(19) United States
(12) Patent Application Publication
(10) Pub. No.: US 2014/0293596 A1
(43) Pub. Date: Oct. 2, 2014

(54) Straight Tube Lamp and Luminaire

(71) Applicant: TOSHIBA LIGHTING & TECHNOLOGY CORPORATION, Yokosuka-shi (JP)

(72) Inventor: Mitsuhiko Nishiie, Yokosuka-shi (JP)

(73) Assignee: TOSHIBA LIGHTING & TECHNOLOGY CORPORATION, Yokosuka-shi (JP)

(21) Appl. No.: 14/032,242

(22) Filed: Sep. 20, 2013

(30) Foreign Application Priority Data
Mar. 27, 2013 (JP) 2013-066685

(51) Int. Cl. F21K 99/00

(52) U.S. Cl. CPC F21K 9/17
USPC 362/222

(57) ABSTRACT

According to one embodiment, a straight tube lamp includes a straight tube cover, at least a portion of which has light transmissivity, and a light-emitting unit including a light-emitting element. A first cap including a pair of terminals for power supply are provided at one end of the cover. A second cap including a pair of terminals for control signals are provided at the other end of the cover. A lighting circuit is arranged in the cover. The lighting circuit is connected to the pair of terminals for power supply, and lights and controls the light-emitting element according to a control signal supplied through the pair of terminals for control signals.

### INCORPORATION BY REFERENCE

The present invention claims priority under 35 U.S.C. §119 to Japanese Patent Application No. 2013-066685 filed on Mar. 27, 2013. The content of the application is incorporated herein by reference in their entirety.

### FIELD

Embodiments described herein relate generally to a straight tube lamp using a light-emitting element and a luminaire using the straight tube lamp.

### BACKGROUND

Hitherto, an LED fluorescent lamp is known which can be substituted for a fluorescent lamp and includes an LED and a lighting circuit. The LED fluorescent lamp is supplied with power from terminals provided at both ends.

Hitherto, in a straight tube lamp including a power supply, a lamp pin attached to a socket of an apparatus is used for power supply, and dimming and toning control cannot be performed.

### BRIEF DESCRIPTION OF THE DRAWINGS

FIG. 1 is a front view showing an inner structure of a straight tube lamp of a first embodiment.

FIG. 2 is a perspective view of the straight tube lamp.

FIG. 3 is a circuit view of a luminaire using the straight tube lamp.

FIG. 4 is a perspective view of the luminaire using the straight tube lamp.

FIG. 5 is a front view of a part of a light-emitting unit of the straight tube lamp.

FIG. 6 is a graph showing the relation between the light outputs of a first color temperature light and a second color temperature light when the dimming ratio between a first light-emitting element and a second light-emitting element is changed while the light flux of the straight tube lamp is made constant.

FIG. 7 is a graph showing the relation between the light outputs of a first color temperature light, a second color temperature light and a synthesized light when the dimming ratio between the first light-emitting element and the second light-emitting element of the straight tube lamp is changed.

FIG. 8 is a front view showing an inner structure of a straight tube lamp of a second embodiment.

FIG. 9 is a front view showing an inner structure of a straight tube lamp of a third embodiment.

### DETAILED DESCRIPTION

In general, according to one embodiment, a straight tube lamp includes a straight tube cover, at least a portion of which has light transmissivity, and a light-emitting unit including a light-emitting element. A first cap including a pair of terminals for power supply is provided at one end of the cover. A second cap including a pair of terminals for control signals is provided at the other end of the cover. A lighting circuit is arranged in the cover. The lighting circuit is connected to the pair of terminals for power supply, and lights and controls the light-emitting element according to a control signal supplied through the pair of terminals for control signals.

In the lamp including a power supply for lighting and controlling the light-emitting element, the lamp pins provided in the caps at both ends for attachment to sockets are used as terminals for signal input. Thus, dimming or toning control can be performed.

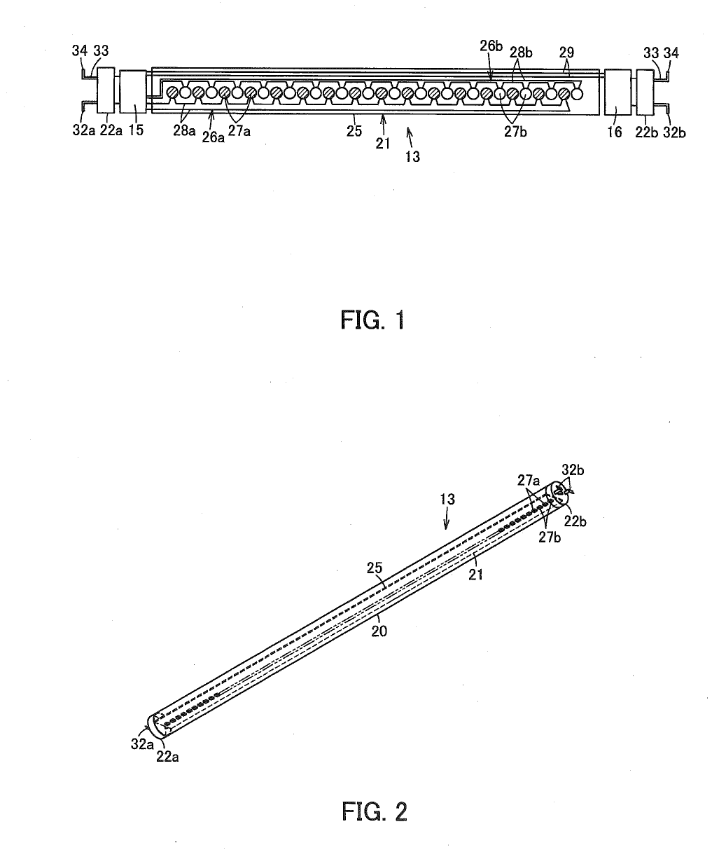

Hereinafter, a first embodiment will be described with reference to FIG. 1 to FIG. 7.

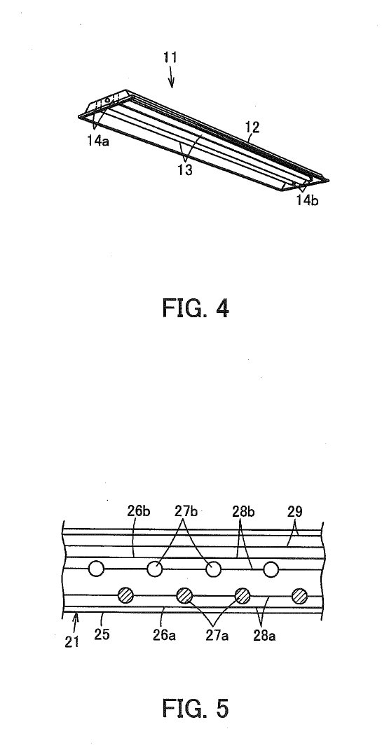

In FIG. 4, a luminaire 11 is, for example, an embedded luminaire with two lights. The luminaire 11 includes a longitudinal luminaire main body 12, a straight tube lamp 13 disposed in the luminaire main body, and a first socket 14a and a second socket 14b which are disposed at both ends of the luminaire main body 12 to face each other and are sockets to which both ends of the straight tube lamp 13 are mounted.

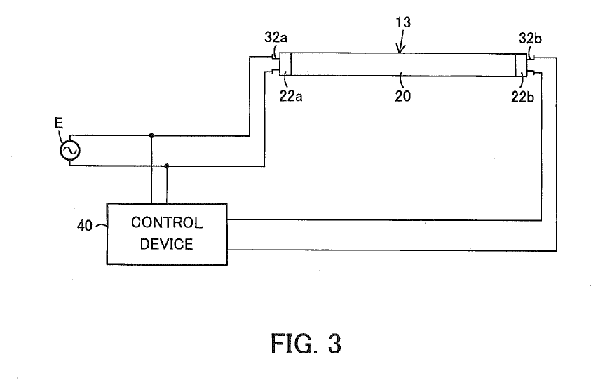

As shown in FIG. 1 and FIG. 2, the straight tube lamp 13 includes a straight-tube-shaped and cylindrical cover 20, a light-emitting unit 21 contained in the cover 20, and a first cap 22a and a second cap 22b as caps disposed at one end and the other end of the cover 20.

The cover 20 has light transmissivity at least in a light irradiation direction, and has a light diffusion property so that the color mixing of plural light colors becomes excellent. The light-emitting unit 21 includes a substrate 25 long in the longitudinal direction of the cover 20. A first light-emitting circuit 26a and a second light-emitting circuit 26b are formed on a mount surface as one main surface of the substrate 25 and are insulated from each other. Plural first light-emitting elements 27a and plural second light-emitting elements 27b are constructed to respectively emit different light colors in total, and are constructed to emit, for example, different color temperature lights.

The first light-emitting circuit 26a includes the plural first light-emitting elements 27a which are mounted on the mount surface of the substrate 25 at a specified interval in the longitudinal direction of the substrate 25 and emit light of a first color temperature, and a first wiring part 28a which are formed on the mount surface of the substrate 25 and connects the plural first light-emitting elements 27a in series.

The second light-emitting circuit 26b includes the plural second light-emitting elements 27b which are mounted on the mount surface of the substrate 25 at a specified interval in the longitudinal direction of the substrate 25 and emit light of a second color temperature different from the first color temperature, and a second wiring part 28b which are formed on the mount surface of the substrate 25 and connects the plural second light-emitting elements 27b in series. For example, the second color temperature is higher than the first color temperature or is lower than the first color temperature. The light-emitting elements 27a and 27b are, for example,

LED elements or EL elements. In the case of the LED elements, for example, a surface mount SMD (Surface Mount Device) package is used.

As shown in FIG. 5, in this embodiment, the first light-emitting elements 27a and the second light-emitting elements 27b are arranged in a center area of the substrate 25 in a short direction thereof and are alternately arranged one by one in one line state in the longitudinal direction of the substrate 25. The first wiring part 28a is disposed on one side of the substrate 25 in the short direction, and the second wiring part 28b is disposed on the other side. By this structure, the insulation state of the first light-emitting circuit 26a and the second light-emitting circuit 26b is ensured. Besides, a pair of signal wirings 29 is disposed from one end in the longitudinal direction of the substrate 25 to the other end. The signal wirings 29 are formed of patterns of copper foil or the like and are insulated from the first wiring part 28a and the second wiring part 28b. The wirings 29 are provided in a space closer to the other side in the short direction of the substrate 25 than the second wiring part 28b.

The caps 22a and 22b are formed to have a common structure. A pair of lamp pins 32a, 32b as a pair of terminals protrudes from an end face of the cap 22a, 22b. The pair of lamp pins 32a, 32b is formed of flat metal plates having square cross-sections. Each of the lamp pins is formed by bending into an L-shape including a leg part 33 protruding in the longitudinal direction of the straight tube lamp 13 and a bent part 34 protruding from an end of the leg part 33 toward an outside direction so as to be separated from the other leg part 33.

Incidentally, in the straight tube lamp 13, the pair of lamp pins 32a, 32b of the cap 22a, 22b at both ends are provided to protrude in parallel to each other. A surface parallel to a direction in which the pair of lamp pins 32a, 32b are arranged side by side is parallel to the substrate 25 of the light-emitting unit 21.

Besides, the pair of lamp pins 32a of the cap 22a is used for power supply, and the pair of lamp pins 32b of the cap 22b are used for signal.

The pair of lamp pins 32a of the first cap 22a are connected to a lighting circuit 15 provided in the cover 20. The lighting circuit 15 is electrically connected to the first light-emitting circuit 26a and the second light-emitting circuit 26b. The pair of lamp pins 32b of the second cap 22b are connected to a dimming circuit 16. The dimming circuit 16 is electrically connected to the lighting circuit 15 through the signal wirings 29 disposed on the substrate 25.

Incidentally, the sockets 14a and 14b are formed to have a common structure, and are constructed such that the caps 22a and 22b of the straight tube lamp 13 are respectively mounted thereto, are electrically connected and are mechanically held.

An erroneous mounting preventing structure may be provided so that at the time of mounting the straight tube lamp 13, the first cap 22a is mounted to the first socket 14a, and the second cap 22b is mounted to the second socket 22a. Alternatively, indication parts or the like may be provided on the sockets 14a and 14b and the caps 22a and 22b so that the mounting direction is clearly understood.

As shown in FIG. 3, in the straight tube lamp 13, power is supplied from a commercial power supply E to the lamp pins 32a of the first cap 22a.

A control device 40 is supplied with power from the AC power supply E and outputs a control signal such as a toning control signal or a dimming control signal. Here, the control signal is not particularly limited. For example, a pulse width modulation signal (PWM) or a DC voltage of 0 to 10V may be outputted as the control signal. The control signal outputted from the control device 40 is supplied to the lamp pins 32b of the second cap 22b.

As shown in FIG. 1 and FIG. 3, the lighting circuit 15 is supplied with power, and generates and outputs lighting power for lighting the first light-emitting elements 27a and lighting power for lighting the second light-emitting elements 27b based on the control signal supplied to the lighting circuit 15 from the lamp pins 32b of the second cap 22b through the signal wirings 29 of the substrate 25. Here, the lighting power may be, for example, DC power or may be PWM-controlled power. Besides, the outputs of the first light-emitting element 27a and the second light-emitting element 27b can be respectively and individually controlled, and dimming or toning control can be performed by the combination of these outputs.

The lighting power such as DC power is supplied from the lighting circuit 15 to the first light-emitting circuit 26a, so that the plural first light-emitting elements 27a connected in series to the first light-emitting circuit 26a are lit. The first color temperature light produced by the first light-emitting elements 27a passes through the cover 20 and is emitted to lighting space. Besides, the lighting power is supplied from the lighting device 15 to the second light-emitting circuit 26b, so that the plural second light-emitting elements 27b connected in series to the second light-emitting circuit 26b are lit. The second color temperature light produced by the second light-emitting elements 27b passes through the cover 20 and is emitted to the lighting space.

In the state where both the first light-emitting elements 27a and the second light-emitting elements 27b are lit, the light in which the first color temperature light produced by the first light-emitting elements 27a and the second color temperature light produced by the second light-emitting elements 27b are mixed passes through the cover 20 and is emitted to the lighting space. At this time, in the center area of the substrate 25 in the short direction, the first light-emitting elements 27a and the second light-emitting elements 27b are alternately arranged in one line state in the longitudinal direction of the substrate 25. Thus, the color mixing of the first color temperature light and the second color temperature light are effectively performed. The cover 20 may be made to have a sufficient light diffusion property so that the color mixing is more effectively performed.

Besides, the powers supplied from the lighting circuit 15 to the first light-emitting circuit 26a and the second light-emitting circuit 26b are changed by the control signal from the control device 40, and the light outputs of the first light-emitting elements 27a and the second light-emitting elements 27b are changed.

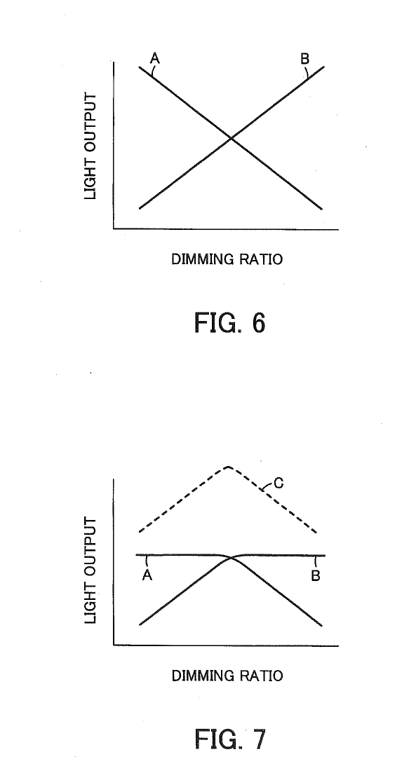

FIG. 6 is a graph showing the relation between the light outputs of a first color temperature light A and a second color temperature light B when the dimming ratio between the first light-emitting element 27a and the second light-emitting element 27b is changed while the light flux of the straight tube lamp 13 is made constant. When the light output from the first light-emitting element 27a is made high, and the light output from the second light-emitting element 27b is made low, the color temperature of the straight tube lamp 13 can be changed to the color temperature with more first color temperature light A. On the other hand, when the light output from the first light-emitting element 27a is made low, and the light output from the second light-emitting element 27b is made high, the color temperature of the straight tube lamp 13 can be changed to the color temperature with more second color temperature light B.

FIG. 7 is a graph showing the relation between the light outputs of a first color temperature light A, a second color temperature light B and a synthesized light C when the dimming ratio between the first light-emitting element 27a and the second light-emitting element 27b of the straight tube lamp 13 is changed. For example, the light output from the second light-emitting element 27b is changed while the light output from the first light-emitting element 27a is constant, or the light output from the first light-emitting element 27a is changed while the light output from the second light-emitting element 27b is constant. As a result, the color temperature of the straight tube lamp 13 can be changed so as to have more first color temperature light A or more second color temperature light B, and the light output of the synthesized light C can also be changed.

As stated above, in the straight tube lamp 13, the control signal is inputted to the lighting circuit 15 to supply the lighting power to the first light-emitting circuit 26a and the second light-emitting circuit 26b which produce different color temperature lights. The color temperature of the light emitted from the straight tube lamp 13 can be arbitrarily changed by the lighting circuit 15 having two system outputs.

Besides, the power input is performed on the cap 22a side at one end, and the control signal input is performed on the cap 22b side at the other end. Thus, the positions of the commercial power supply and the control signal as a low voltage and minute current are separated, and noise can be reduced.

Besides, since the signal wirings 29 are mounted on the substrate 25, complication of wiring in the cover 20 can be prevented. Further, in a manufacturing process, defects, such as entanglement of signal wires or being assembled in a state of contact with a power supply line, are reduced.

Further, since the power supply line and the signal line are separated, the restriction of an insulation distance is minimized, and miniaturization can be realized.

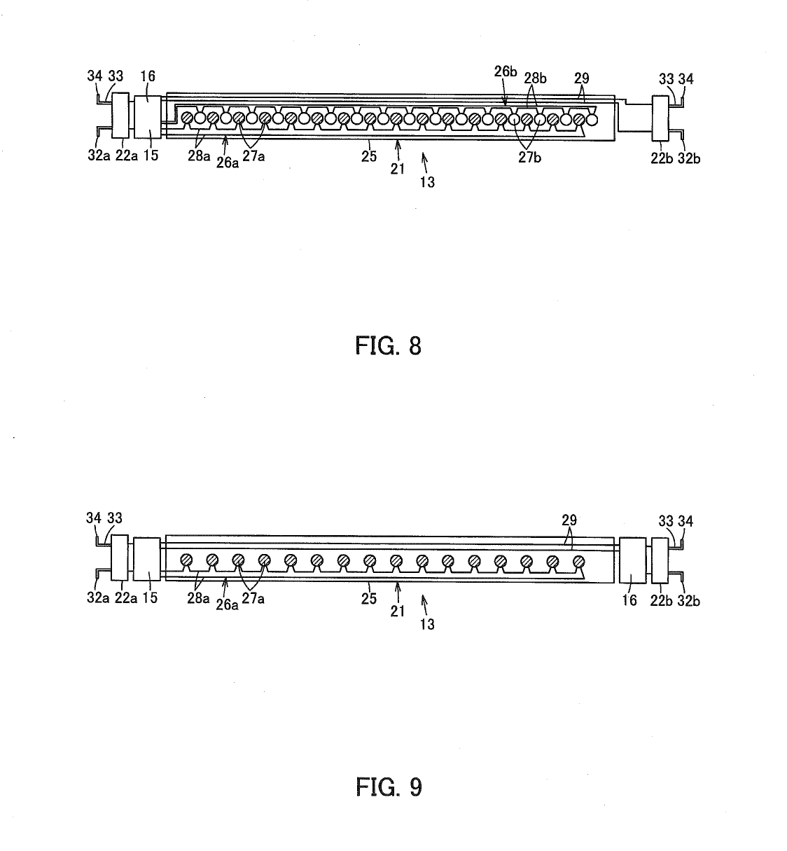

FIG. 8 shows a second embodiment. The same reference numerals as in the first embodiment are used, and the description of the same components and effects is omitted.

The second embodiment is different from the first embodiment in that a dimming circuit 16 is provided integrally with a lighting circuit 15. By this, a structure on a second cap 22b side is simplified, and a straight tube lamp which can be easily assembled can be realized.

FIG. 9 shows a third embodiment. The same reference numerals as in the first embodiment are used, and the description of the same components and effects is omitted.

The third embodiment is different from the first embodiment in that only first light-emitting elements 27a are mounted on a substrate 25.

In this embodiment, a dimming signal is transmitted as a control signal, and a lighting circuit 15 controls the light output of the first light-emitting elements 27a according to the dimming signal. Incidentally, a dimming circuit 16 may be constructed integrally with the lighting circuit 15 as in the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A straight tube lamp comprising:
a straight tube cover, at least a portion of which has light transmissivity;
a light-emitting unit including a light-emitting element;
a first cap which is provided at one end of the cover and includes a pair of terminals for power supply;
a second cap which is provided at the other end of the cover and includes a pair of terminals for control signals; and
a lighting circuit which is arranged in the cover, is connected to the pair of terminals for power supply, and lights and controls the light-emitting element according to a control signal supplied through the pair of terminals for control signals.

2. The lamp according to claim 1, wherein
the light-emitting unit includes a substrate on which the light-emitting element is mounted, and a pair of signal wirings disposed on the substrate from one end to the other end in a longitudinal direction thereof, and
the control signal inputted to the pair of terminals for control signals is supplied to the lighting circuit through the signal wirings.

3. The lamp according to claim 1, wherein
the light-emitting unit includes a first light-emitting element to emit light of a first light color, and a second light-emitting element to emit light of a second light color different from the first light color in color temperature, and
the lighting circuit lights and controls the first light-emitting element and the second light-emitting element according to the control signal inputted to the pair of terminals for control signals.

4. The lamp according to claim 1, further comprising a dimming circuit which is arranged in the cover, is connected to the pair of terminals for control signals, and supplies the control signal to the lighting circuit.

5. The lamp according to claim 4, wherein the lighting circuit is disposed at one end of the cover, and the dimming circuit is disposed at the other end of the cover.

6. The lamp according to claim 4, wherein the dimming circuit is provided integrally with the lighting circuit.

7. A luminaire comprising:
a straight tube lamp that includes a straight tube cover, at least a portion of which has light transmissivity, a light-emitting unit including a light-emitting element, a first cap which is provided at one end of the cover and includes a pair of terminals for power supply, a second cap which is provided at the other end of the cover and includes a pair of terminals for control signals, and a lighting circuit which is arranged in the cover, is connected to the pair of terminals for power supply, and lights and controls the light-emitting element according to a control signal supplied through the pair of terminals for control signals;
a pair of sockets to which the caps at both the ends of the straight tube lamp are respectively mounted; and
a control device to input the control signal to one of the sockets to which the second cap is connected.

8. The luminaire according to claim 7, wherein the light-emitting unit includes a substrate on which the light-emitting element is mounted, and a pair of signal wirings disposed on the substrate from one end to the other end in a longitudinal direction thereof, and
the control signal inputted to the pair of terminals for control signals is supplied to the lighting circuit through the signal wirings.

9. The luminaire according to claim 7, wherein
the light-emitting unit includes a first light-emitting element to emit light of a first light color, and a second light-emitting element to emit light of a second light color different from the first light color in color temperature, and
the lighting circuit lights and controls the first light-emitting element and the second light-emitting element according to the control signal inputted to the pair of terminals for control signals.

10. The luminaire according to claim 7, further comprising a dimming circuit which is arranged in the cover, is connected to the pair of terminals for control signals, and supplies the control signal to the lighting circuit.

11. The luminaire according to claim 10, wherein the lighting circuit is disposed at one end of the cover, and the dimming circuit is disposed at the other end of the cover.

12. The luminaire according to claim 10, wherein the dimming circuit is provided integrally with the lighting circuit.
